(19) United States
(12) Patent Application Publication
(10) Pub. No.: US 2026/0178838 A1
(43) Pub. Date: Jun. 25, 2026

(54) SYSTEM AND METHOD FOR AUTOMATED MULTI-SPEAKER AND MULTI-LINGUAL SPEECH ANALYSIS

(71) Applicant: eResearch Technology, Inc., Philadelphia, PA (US)

(72) Inventor: Alexandre Boudreau, Philadelphia, PA (US)

(73) Assignee: eResearch Technology, Inc., Philadelphia, PA (US)

(21) Appl. No.: 19/001,149

(22) Filed: Dec. 24, 2024

(51) Int. Cl. G06F 40/35; G10L 15/04; G10L 15/26; G10L 25/30; G10L 25/78

(52) U.S. Cl. CPC G06F 40/35; G10L 15/04; G10L 15/26; G10L 25/30; G10L 25/78

(57) ABSTRACT

Exemplary system and methods use a combination of application modules and neural network architecture for multi-speaker and multi-language speech analysis. The exemplary system can receive a natural language input, which it decomposes into plural segments. A sub-group of the plural segments are accumulated in a buffer where each segment representing a period during which voice activity is detected. The sub-groups are analyzed for voice activity of multiple speakers and one or more text segments are generated based on the speakers. A semantic vector for each text segment is generated and stored in vector memory. Relevant data associated with each semantic vector is retrieved from the vector memory based on a similarity measure; and a response including specified information extracted from the one or more text segments is generated based on at least the relevant data.

### FIELD

The subject matter disclosed relates generally to speech analysis, and particularly to multi-speaker and multi-lingual speech analysis.

### BACKGROUND

Latest advancements with Large Language Models (LLMs) have helped augment and improve general Natural Language Processing and Understanding (NLP/NLU). What previously required customized model training for the accurate extraction of data entities and information summarization from text, can now be achieved through the combination of Retrieval Augmented Generation (RAG), embedding models, and large language models. However, even if LLMs are increasingly multi-lingual, they currently lack the ability to effectively work with live speech or speech audio recordings and do not support the attribution of speech to a specified speaker.

To automatically extract key information from speech data, known systems employ a combination of methods such as voice activity detection, automated speech recognition, and some form of NLP pipeline that is trained and programmed to look for specified text entities. This approach is a “hardwired” process that requires expert audio and NLP researchers and software engineers to analyze the NLP results and refine the model, if necessary. The complexity of the problem is further increased when multiple speakers are present in the speech and where there is a need to associate the extracted data to the correct speaker. The complexity again further increases when multiple languages are involved in speech and in the desired analysis output. Because of the “hardwired” pipeline of current systems, extracting new types of data from the speech will require developing a new feature to support this task.

### SUMMARY

An exemplary system for multi-lingual speech analysis is disclosed, the system comprising: memory configured to store program code for performing speech analysis; a processor configured to execute the program code, and upon execution of the program code, the processor being configured to generate one or more application modules and at least one trained neural network which further configure the processor to: receive, by the one or more application modules, a natural language input; decompose, by the one or more application modules, the natural language input into plural segments; accumulate, by the one or more application modules, a sub-group of the plural segments in a buffer, each segment representing a period during which voice activity is detected; analyze, by the one or more application modules, at least one sub-group of segments to determine whether the voice activity includes speech generated by plural speakers; generate, by the one or more application modules, one or more text segments from the at least one sub-group of audio segments based on the plural speaker determination; generate, by the one or more application modules and one trained neural network, a semantic vector for each text segment and store each semantic vector in vector memory; retrieve, by one or more application modules, relevant data associated with each semantic vector from the vector memory; and generate, by the at least one trained neural network, a response including specified information extracted from the one or more text segments based on at least the relevant data.

An exemplary method for multi-lingual speech analysis is disclosed, the method comprising: storing, by a storage device, program code for performing speech analysis; executing, by a processor, the program code stored in the storage device, the program code causing the processor to be configured to include one or more application modules and at least one trained neural network which causes the processor to perform operations including: receiving, by the one or more application modules, a natural language input; decomposing, by the one or more application modules, the natural language into plural segments; accumulating, by the one or more application modules, a sub-group of the plural segments in a buffer, each segment representing a period during which voice activity is detected; analyzing, by the one or more application modules, at least one sub-group of segments to determine whether the voice activity includes speech generated by plural speakers; generating, by the at least one trained neural network, one or more text segments from the at least one sub-group of audio segments based on the plural speaker determination; generating, by the at least one trained neural network, a semantic vector for each text segment and store each semantic vector in vector memory; retrieving, by the at least one trained neural network, relevant data associated with each semantic vector from the vector memory; and generating, by the at least one trained neural network, a response included specified information extracted from the one or more text segments based on at least the relevant information, wherein the response includes a text summary of the voice activity for each text segment.

An exemplary non-transitory computer readable medium encoded with system program code for performing speech analysis is disclosed, the computer readable medium when placed in communicable contact with a processor, the computer readable medium causing the processor to generate one or more application modules and at least one trained neural network and be configured to: receive, by the one or more application modules, a natural language input; decompose, by the one or more application modules, the natural language input into plural segments; accumulate, by the one or more application modules, a sub-group of the plural segments in a buffer, each segment representing a period during which voice activity is detected; analyze, by the one or more application modules, at least one sub-group of segments to determine whether the voice activity includes speech generated by plural speakers; generate, by the one or more application modules, one or more text segments from the at least one sub-group of audio segments based on the plural speaker determination; generate, by the one or more application modules, a semantic vector for each text segment and store each semantic vector in vector memory; retrieve, by the at least one trained neural network, relevant data associated with each semantic vector from the vector memory; and generate, by the at least one trained neural network, a response included specified information extracted from the one or more text segments based on at least the relevant information, wherein the response includes a text summary of the voice activity for each text segment.

An exemplary system for multi-lingual speech analysis is disclosed, the system comprising: memory configured to store program code for natural language analysis; a processor configured to execute the program code, the program code causing the processor to be configured to: receive, by one or more application modules, a natural language input from a user interface; generate, by the one or more application modules, one or more text segments from the natural language input; analyze, by the one or more application modules, each text segment to determine a source language of text included in the one or more text segments; translate, by the one or more application modules, the one or more text segments from the source language determined for the associated audio segment to a target language selected by a user; generate, by the at least one trained neural network, a vector of each text segment and store the vector in vector memory; performing, by the at least one trained neural network, a semantic search on the vector memory to retrieve information related to the vector; passing, by the at least one trained neural network, the retrieved information and the natural language input to another neural network; and generating, by the other one neural network, a response to the natural language input based on at least the information retrieved from the vector store.

### DESCRIPTION OF THE DRAWINGS

Exemplary embodiments are best understood from the following detailed description when read in conjunction with the accompanying drawings. Included in the drawings are the following figures:

FIG. 1 illustrates a system for multi-lingual speech analysis in accordance with an exemplary embodiment of the present disclosure.

FIG. 2 illustrates a neural network structure in accordance with an exemplary embodiment of the present disclosure.

FIG. 3 illustrates a data process flow for automated speech analysis in accordance with an exemplary embodiment of the present disclosure.

FIG. 4 illustrates a data process flow for interactive speech analysis in accordance with an exemplary embodiment of the present disclosure.

FIG. 5 illustrates a method for multi-lingual speech analysis in accordance with an exemplary embodiment of the present disclosure.

FIG. 6 illustrates a method for interactive speech analysis in accordance with an exemplary embodiment of the present disclosure.

FIG. 7 illustrates a hardware implementation in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

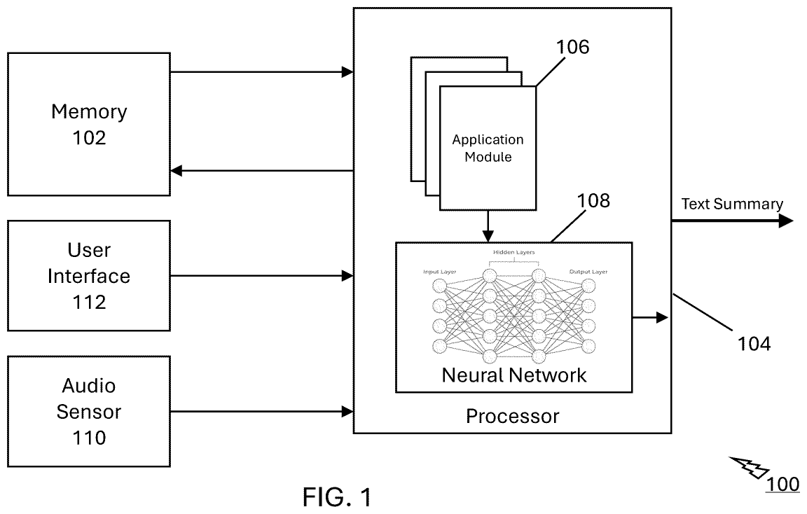

FIG. 1 illustrates a system for multi-lingual speech analysis in accordance with an exemplary embodiment of the present disclosure. As shown in FIG. 1, the system 100 can configured as a computing system that includes memory 102 and a processor 104. The memory 102 can include one or more storage devices configured to store at least program code for performing speech analysis. According to an exemplary embodiment, the memory 102 can also store data, such as model parameters, speech data, feature data, and processing results, and any other information as desired. The memory 102 can include one or more devices that are resident to the computing system, external to the computing system, or a combination of both. The processor 104 can be configured to execute the program code stored in memory 102, and upon execution of the program code, the processor 104 is configured to generate one or more application modules 106 and at least one trained neural network 108 for performing operations for multi-lingual speech analysis. The one or more application modules 106 can include an application executed by the processor 104 which is configured to execute a specific task and/or operation related the multi-lingual speech analysis. According to an exemplary embodiment, the one or more application modules 106 can include an application programming interface configured to communicate with one or more processes executed by a remote server.

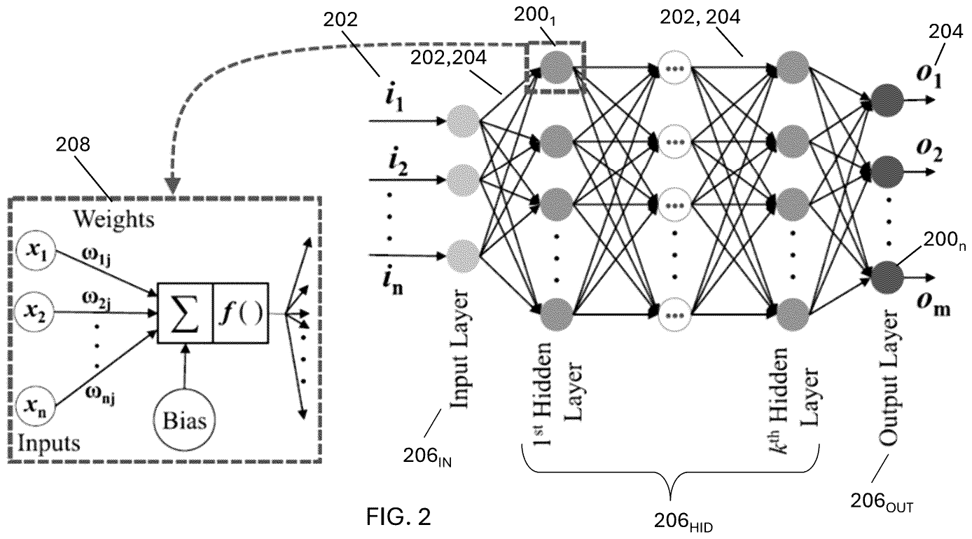

FIG. 2 illustrates a neural network structure in accordance with an exemplary embodiment of the present disclosure. The trained neural network 108 can include one or more artificial intelligence (AI) or machine learning models (ML). The neural network 108 can be formed based on deep learning (DL) network architectures that use interconnected nodes or neurons in a layered structure that resembles the human brain. The neural network 108 can include plural nodes 200₁ to 200ₙ that represent individual computational units. Each node 200ₙ has one or more biased input/output connections that function as transfer or activation functions for combining the inputs and outputs in a specified manner. As shown in FIG. 2 the neural network 108 each node 200ₙ has one or more inputs 202 and outputs 204 for processing the speech input. The plural nodes 200ₙ can be arranged in multiple layers 206. The scheme within which the nodes 200ₙ are connected determines the type and operation of the neural network 108. For example, the neural network 108 can include an input layer 206_{IN}, multiple hidden layers 206_{HID}, and an output layer 206_{OUT}. Each layer 206 may perform a different or specified transformation on the respective inputs, using a different or specified mathematical calculation or function. Signals travel or are passed between the layers 206, from the input layer 206_{IN} to the output layer 206_{OUT} via the middle or hidden layers 206_{HID} and can traverse any layer 206 and node(s) 200ₙ multiple times. As shown in FIG. 2, the nodes 200ₙ can be connected in an array and each node can transmit a signal to a node in another layer 206 of the neural network 108. The input/output connections 202, 204 between the nodes 200ₙ have a corresponding weight wₙⱼ 208 and are combined according to the bias applied at each node 200ₙ. For example, the connections 202, 204 are activation or transfer functions which trigger the respective nodes and combine inputs according to mathematical equations or formulas according to the bias. According to these neural network principles, a speech input is received at the input layer 206_{IN} of the neural network and passed through multiple hidden layers 206_{HID} until an epoch score and/or local metric is generated at the output layer 206_{OUT}. As the speech signal is passed between the multiple nodes 200ₙ and layers 206, various features of the speech are identified and/or extracted, the level of feature extraction becomes more granular with each additional layer to which the signal is passed.

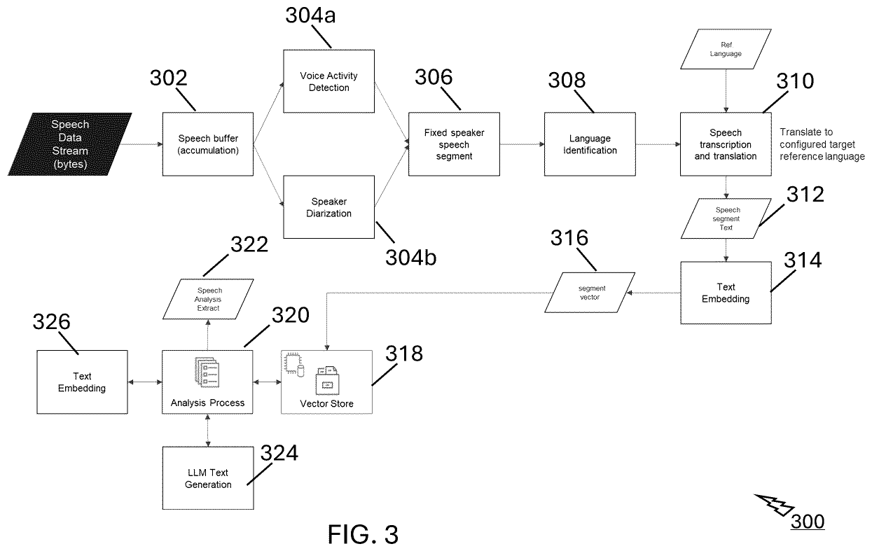

FIG. 3 illustrates a data process flow for automated speech analysis in accordance with an exemplary embodiment of the present disclosure. Once the processor 104 executes the program code, the processor 104 is configured to receive, by the one or more application modules 106, a natural language input. The natural language input can include a data file that is stored in memory 102. The data file can be in a format that supports streaming audio. According to another exemplary embodiment, the natural language input can include streaming audio data. As shown in FIG. 3, the natural language input when received in a streaming audio format can be buffered (302) in memory 102. The system 100 can include an audio sensor 110 configured to generate an electrical signal based on sound waves that are detected and measured in an environment in which it is disposed. For example, the audio sensor 110 can include one or more of a microphone, a transducer, an acoustic sensor, or any other suitable sensor or combination of sensors as desired. The processor 104 can have a wired or wireless connection to the audio sensor 110 such that the application module(s) 106 can receive the audio data. After receiving the audio data, the application module(s) 106 can decompose the natural language input into plural segments. For example, the application module(s) 106 can be configured to perform audio segmentation in which the audio signal is divided into a sequence of segments or frames. According to an exemplary embodiment, each segment can have one or more parameters in common such as frequency, amplitude, duration, or any other suitable parameter(s) as desired. After segmenting the audio data, the application module(s) 106 can be configured to determine whether voice activity is present in each segment (304a). For example, voice activity can be detected by analyzing the one or more frequencies in the audio data to determine whether they match one or more known vocal characteristics. The application module(s) 106 can accumulate a sub-group of the plural segments in a buffer, which can be included in a portion of the memory 102. Each segment in the sub-group represents a period within the segment during which voice activity is detected. Further, the application module(s) 106 analyzes at least one sub-group of segments to determine whether the voice activity includes speech generated by plural speakers. For example, to generate and analyze at least one sub-group of segments from the plural segments, the application module(s) 106 can identify each speaker that generates speech in the voice activity of the at least one sub-group of segments. The processor 104 can be configured to perform voice biometrics, speaker diarization, or any other suitable technique or operation as desired to identify each speaker that generates speech in the at least one sub-group of segments (304b). According to an exemplary embodiment, the at least one sub-group of segments can include at least one segment for each identified speaker (306).

Once all speech is detected and the speakers identified in the sub-group of plural segments the application module(s) 106 can generate one or more text segments from the at least one sub-group of segments based on the plural speaker determination. In generating the text segment(s), the application module(s) can also determine a source language of the speech included in each segment (308). For example, the application module(s) can be configured to extract specified portions or elements (e.g., words, letters, phrases, etc.) of the text generated from the speech segments and compare the extracted portions or elements to a language database to identify the source or reference language (310). According to an exemplary embodiment, the data can be extracted from the one or more text segments based on predefined prompts received from the user through a user interface 112 (312). The user interface 112 can include device comprised of a combination of software and hardware components. In an exemplary embodiment, the user interface 112 can include a keyboard, mouse, touchscreen, microphone, any other suitable device or combination thereof as desired. Each predefined prompt can be associated with a specified data domain, such as a topic, subject, theme, concept or any other suitable domain as desired. For example, the domain can specify a profession, technology, sport, etc. According to an exemplary embodiment, the user interface can receive an input and/or command from the user to translate the one or more text segments from the source language determined for the associated segment to a target language selected by a user. The application module(s) 106 can determine whether all speech in the one or more text segments has been translated and vectorized, prior to the text being extracted. A specific type of neural network (108), called an embedding model, is used to convert the text segments (312) from the input speech into vectors called embeddings (314, 316), which are then stored in vector memory for later retrieval (318). Once sufficient speech in the one or more text segments has been processed, key information from the audio data can be extracted using a combination of neural networks, including the embedding model and a large language model, as well as pre-defined prompts that provide instructions for the language model and /r one or many examples of the information that is to be extracted. According to an exemplary embodiment, a pre-defined “prompts” can be an instruction for the model to identify a study ID that was referred to by the speaker. An exemplary prompt can include as follows:
“What is the Study ID referenced by the speaker. An example of Study ID format is Study-1234. Respond uniquely with the Study ID string. If no study ID is referenced, respond with ‘None’.”

This prompt can be used by the Analysis Process component (320) to retrieve the relevant portion of the user's speech from the vector store (318) that reference study IDs, and also be used as instructions for the LLM to generate the required response (324). The prompts are embedded using the embedding model, and the relevant information from the speaker is identified by performing a semantic analysis on the text segments using a retrieval operation with an embedding distance function such as cosine similarity. The vector of the text segment is stored in vector memory (318). For example, the vector memory can include the memory 102 and/or a suitable external memory device connected to the system 100.

The one or more application modules(s) 106 and the trained neural network 108, can use the extracted key information to perform a semantic similarity search on the vector store. Here the application module(s) 106 retrieves relevant data from the vector store by estimating semantic similarity between words or documents based on their contextual relationships in a corpus of electronic text (320). Once the relevant data is retrieved, the application module(s) can perform a similarity measure, such as cosine distance, or other suitable method for determining similarity as desired. The trained neural network can receive the relevant data and the predefined prompts and generate a response (324).

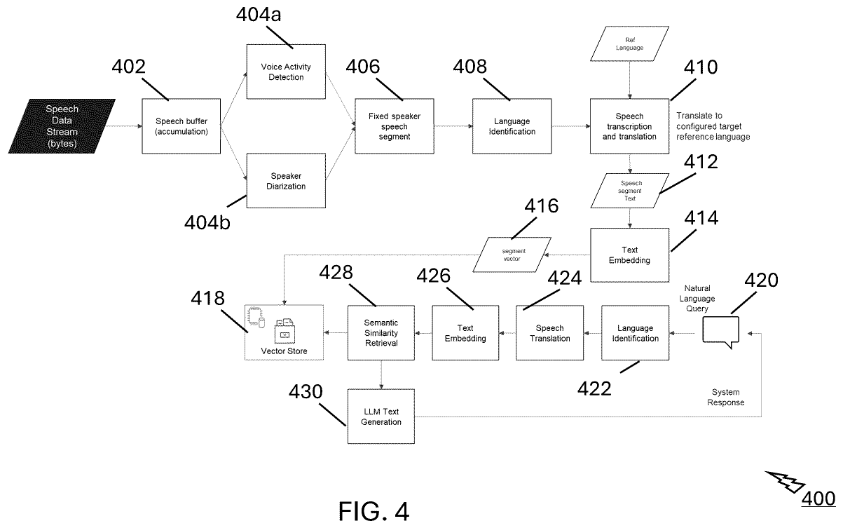

FIG. 4 illustrates a data process flow for interactive speech analysis in accordance with an exemplary embodiment of the present disclosure. As shown in FIG. 4, the processor 104 can be configured to execute program code stored in memory for performing speech analysis. Once executed the processor 104 can generate one or more application modules and a trained neural network. As a result, the computer system 100 can receive, by one or more application modules, a natural language input from a user interface 112. As already discussed, the natural language input can be received on one of plural formats including a static audio file, a data file having streaming audio data, and/or as real-time or near real-time streaming audio data (400). The processor 102 can buffer the streaming audio data in memory as it is received (402). After receiving the audio data, the application module(s) 106 can decompose the natural language input into plural segments and perform and detection operation to determine whether voice activity is present in each segment (404a). Further, the application module(s) 106 analyzes at least one sub-group of segments to determine whether the voice activity includes speech generated by plural speakers, and perform voice biometrics, speaker diarization, or any other suitable technique or operation as desired to identify each speaker that generates speech in the at least one sub-group of segments (404b). According to an exemplary embodiment, the at least one sub-group of segments can include at least one segment for each identified speaker (406).

Next, the application module(s) 106 can generate one or more text segments from the at least one sub-group of segments based on the plural speaker determination and determine a source language of the speech included in each segment (408). The application module(s) can extract specified portions or elements (e.g., words, letters, phrases, etc.) of the text generated from the speech segments and compare the extracted portions or elements to a language database to identify the source or reference language (410). According to an exemplary embodiment, the data can be extracted from the one or more text segments based on predefined prompts received from the user by the user interface (412). The neural network 108 can perform a semantic analysis on the text segments by converting each text segment into numerical vectors that represent the text's meaning and context (414) and store each vector in vector memory (418).

When a natural language query is received (420), the system can process the natural language query by segmenting the natural language input, converting the input to text, and identifying a source language for the query (422). According to an exemplary embodiment, the natural language query can include an instruction or question that is to be performed on the analyzed speech with vectors stored in vector memory 418. The speech can be input as text or speech. The application module(s) 106 process the input into a text format, if necessary, translate the text to a reference language (424) and perform a text embedding operation to extract relevant data from the instruction using pre-defined prompts, as already discussed (426). The neural network 108 performs a semantic similarity search on the vector memory to retrieve information related to the numerical vector of the text (428). The trained neural network (430) generates a response to the natural language input based on the retrieved information and sends the response to the user interface 112.

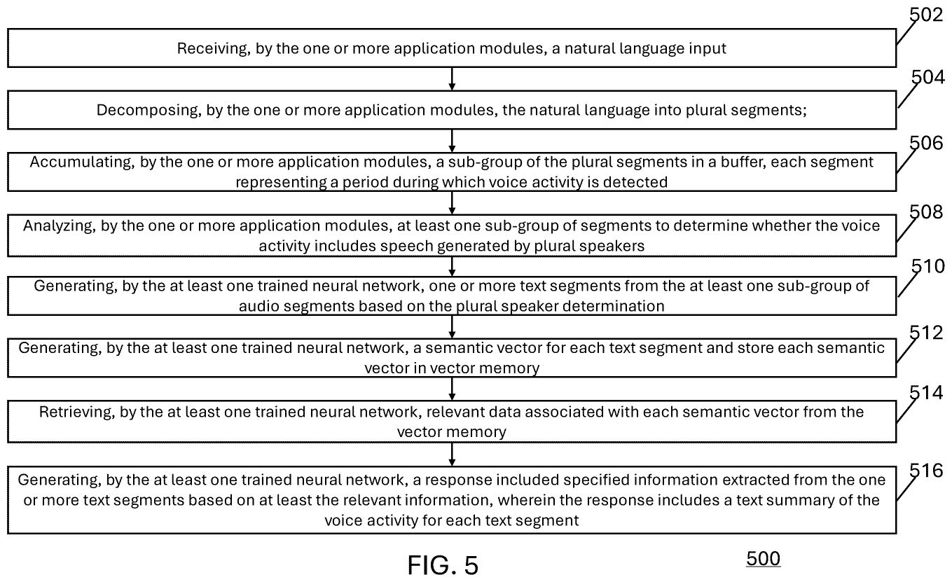

FIG. 5 illustrates a method for multi-lingual speech analysis in accordance with an exemplary embodiment of the present disclosure. In step 502, the method 500 includes receiving, by the one or more application modules, a natural language input. The natural language input is decomposed, by the one or more application modules, into plural segments (step 504). The method further includes accumulating, by the one or more application modules, a sub-group of the plural segments in a buffer, each segment representing a period during which voice activity is detected (step 506), and in step 508 analyzing, by the one or more application modules, at least one sub-group of segments to determine whether the voice activity includes speech generated by plural speakers. The one or more text segments are generated, by the at least one trained neural network, from the at least one sub-group of audio segments based on the plural speaker determination (step 510). In steps 512 and 514, the at least one trained neural network generates a semantic vector for each text segment and store each semantic vector in vector memory, and retrieves relevant data associated with each semantic vector from the vector memory. The method further includes generating, by the at least one trained neural network, a response included specified information extracted from the one or more text segments based on at least the relevant information (step 516). According to an exemplary embodiment, the response includes a text summary of the voice activity for each text segment.

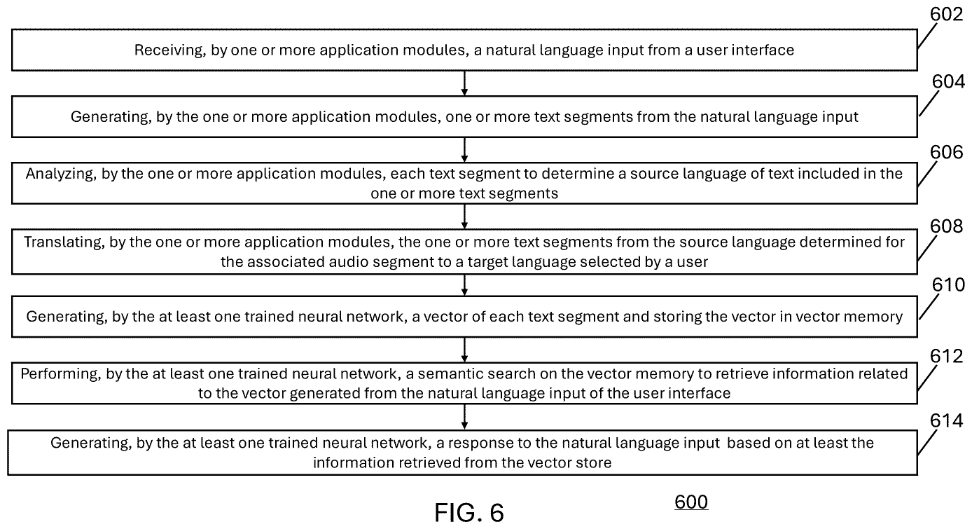

FIG. 6 illustrates a data process flow for interactive speech analysis in accordance with an exemplary embodiment of the present disclosure. In step 602 of the method 600, the one or more application modules receive a natural language input from a user interface. The one or more application modules generates one more text segments from the input (604) and analyzes each text segment to determine a source language of text included in the one or more text segments (step 606). The method 600 further includes translating, by the one or more application modules, the one or more text segments from the source language determined for the associated audio segment to a target language selected by a user (step 608). In step 610, the at least one trained neural network generates a vector of each text segment and stores the vector in vector memory. The at least one trained neural network, searches the vector memory to retrieve information related to the vector generated from the natural language input of the user interface (step 612). The method further includes generating, by the at least one trained neural network, a response to the natural language input based on at least the information retrieved from the vector store (step 614).

The exemplary system and methods of the present disclosure can be implemented using a number and arrangement of systems, hardware, and/or modules (e.g., software instructions). For example, the system can be a combination of two or more systems, hardware, and/or modules or may be implemented within a single system, hardware, and/or module. A single system, hardware, and/or module may be implemented as multiple, distributed systems, hardware, and/or modules. Additionally, or alternatively, a set of systems, a set of hardware, and/or a set of modules (e.g., one or more systems, one or more hardware devices, one or more modules) may perform one or more functions described as being performed by another set of systems, another set of hardware, or another set of modules.

The system can be implemented in a configuration suitable for multi-lingual speech analysis as disclosed herein. For example, various components of the system may be implemented in one or more computing devices (e.g., one or more servers, client devices, user devices, and/or the like) and the one or more computing devices may be connected via a communications network (e.g., the Internet).

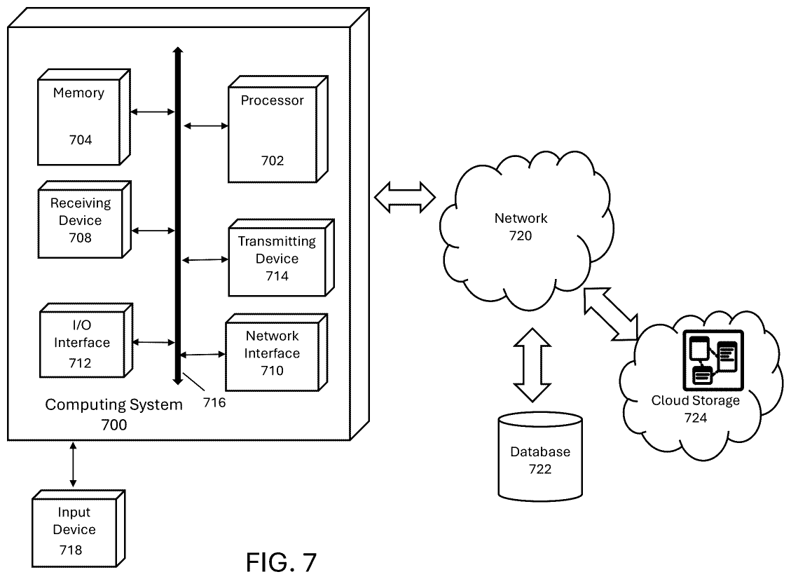

FIG. 7 illustrates an exemplary hardware configuration of a system according to an exemplary embodiment of the present disclosure. As shown in FIG. 7, the system may include a computing system 700. The computing system 700 may include a processor (e.g., CPU) 702 and memory 704. The processor 702 may execute software instructions (e.g., program code) for multi-lingual speech analysis. The computing system 700 as disclosed herein, can be configured for running inference on multiple types of machine learning and/or artificial intelligence models (e.g., embedding models, neural machine translation models, large language models, other types of deep neural networks, neural networks, and/or the like) and for multi-lingual speech analysis and generating a response with trained machine learning models.

The processor 702 may be implemented in hardware, software, or a combination of hardware and software. For example, the processor 702 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function.

Memory 704 may include random access memory (RAM), read-only memory (ROM), and/or another type of dynamic or static storage device (e.g., flash memory, magnetic memory, optical memory, etc.) that stores information and/or software instructions for use by the processor 702. Memory 704 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 704 from another computer-readable medium or from another device via a communication interface with computing device. When executed, software instructions stored in memory may cause the processor to perform one or more processes described herein. Embodiments described herein are not limited to any specific combination of hardware circuitry and software.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor 702 may be implemented solely as software or firmware associated with the processor 702.

The processor 702 can include one or more processing or operating modules. A processing or operating module can be a software or firmware operating module configured to implement any of the functions disclosed herein. The processing or operating module can be embodied as software and stored in memory 704. The memory 704 being operatively associated with and communicably coupled to the processor 702. A processing module can be embodied as a web application, a desktop application, a console application, etc.

The processor 702 can include or be associated with a computer or machine readable medium. The computer or machine readable medium can include memory. Any of the memory discussed herein can be computer readable memory configured to store data. The memory 704 can include a volatile or non-volatile, transitory, or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory 704 can be a non-transitory computer-readable medium. The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory 704 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration 722, such as a relational database, a structured query language (SQL) database, a distributed database, an object database, etc. According to an exemplary embodiment, the data can be stored on one or more device configured to operate as cloud storage 724 on a network 720. Suitable configurations and storage types will be apparent to persons having skill in the relevant art.

The exemplary computing device 700 can also include a communications interface 706. The communications interface 706 can be configured to allow software and data to be transferred between the computing device and external devices. Exemplary communications interfaces 706 can include a modem, a network interface (e.g., an Ethernet card), a communications port, a PCMCIA slot and card, etc. Software and data transferred via the communications interface 706 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

According to exemplary embodiments described herein, the combination of the memory 704 and the processor 702 can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from computing devices located on a local-area or wide-area network and/or in a cloud-computing arrangement or environment. In another example, the computer programs (e.g., computer control logic) or software may be stored in memory resident on/in the computing device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The computing system 700 or device may also include a receiver or receiving device 708, a network interface 710, an input/output (I/O) interface 712, a transmitting device 714, a communication infrastructure 716, an input device 718, a communication network 720, and a database 722 and/or cloud storage 724.

The receiver or receiving device 708 may be a combination of hardware and software components configured to receive data samples from the mobile network or database. According to exemplary embodiments, the receiving device 708 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 708 can be an input device for receiving signals and/or data samples formatted according to 3GPP protocols and/or standards. The receiving device 708 can be connected to other devices via a wired or wireless network or via a wired or wireless direct link or peer-to-peer connection without an intermediate device or access point. The hardware and software components of the receiving device 708 can be configured to receive the data from the mobile network according to one or more communication protocols and data formats. For example, the receiving device 708 can be configured to communicate over a network 720, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 708 can be configured to identify parts of the received data via a header and parse the data signal and/or data packet into small frames (e.g., bytes, words) or segments for further processing at the processor.

The I/O interface 712 can be configured to receive the signal from the processor and generate an output suitable for a peripheral device via a direct wired or wireless link. The I/O interface 712 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 714 can be configured to receive data from the processor and assemble the data into a data signal and/or data packets according to the specified communication protocol and data format of a peripheral device or remote device to which the data is to be sent. The transmitting device 714 can include any one or more of hardware and software components for generating and communicating the data signal over the communications infrastructure and/or via a direct wired or wireless link to a peripheral or remote device. The transmitting device 714 can be configured to transmit information according to one or more communication protocols and data formats as discussed in connection with the receiving device.

The input device 718 is configured to receive an input from a user for processing and/or use by the CPU 702. For example, the input device 718 can be implemented as a physical or virtual keyboard, a physical or virtual touchpad, a microphone, or any suitable device for inputting data or information as desired. The input device 718 can be configured to format the received user input suitable for use by the CPU 702 or be configured to provide the user input to the I/O interface 712 for further processing. According to an exemplary embodiment, the input device 718 can be configured to communicate wirelessly with the computing system 700 or be integrated into the housing of the computing system 700 or have a physical connection to the computing device 700. In performing the described operations, the input device 718 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for multi-lingual speech analysis, the system comprising:
memory configured to store program code for performing speech analysis;
a processor configured to execute the program code, and upon execution of the program code, the processor being configured to generate one or more application modules and at least one trained neural network which further configure the processor to:
receive, by the one or more application modules, a natural language input;
decompose, by the one or more application modules, the natural language input into plural segments;
accumulate, by the one or more application modules, a sub-group of the plural segments in a buffer, each segment representing a period during which voice activity is detected;
analyze, by the one or more application modules, at least one sub-group of segments to determine whether the voice activity includes speech generated by plural speakers;
generate, by the one or more application modules, one or more text segments from the at least one sub-group of audio segments based on the plural speaker determination;
generate, by the one or more application modules and one trained neural network, a semantic vector for each text segment and store each semantic vector in vector memory;
retrieve, by one or more application modules, relevant data associated with each semantic vector from the vector memory; and
generate, by the at least one trained neural network, a response including specified information extracted from the one or more text segments based on at least the relevant data.

2. The system according to claim 1, wherein the natural language input is a data file that includes streaming audio data.

3. The system according to claim 1, wherein the natural language input includes streaming audio data.

4. The system according to claim 1, to decompose the natural language input into plural segments, the processor is further configured to:
determine, by the one or more application modules, whether voice activity is present in each segment.

5. The system according to claim 4, wherein to generate at least one sub-group of segments from the plural segments, the processor is further configured to:
identify each speaker that generates speech in the voice activity of the at least one sub-group of segments.

6. The system according to claim 5, wherein the at least one sub-group of segments includes at least one segment for each identified speaker.

7. The system according to claim 6, wherein to generate one or more text segments, the processor is further configured to:
determine a source language of the speech included in each segment.

8. The system according to claim 7, wherein the processor is further configured to:
translate the one or more text segments from the source language determined for the associated segment to a target language selected by a user.

9. The system according to claim 8, wherein to extract specified data from the one or more text segments, the processor is further configured to:
determine whether all speech in the one or more text segments has been translated and vectorized, prior to the structured data being extracted.

10. The system according to claim 9, wherein the specified data is extracted from the one or more text segments based on predefined prompts, each predefined prompt being associated with specified data domain.

11. The system according to claim 10, wherein to retrieve relevant data associated with each semantic vector from the vector memory, the processor is further configured to:
search the vector memory based on the specified data to identify the relevant data associated with the one or more text segments that is stored in the vector memory.

12. A method for multi-lingual speech analysis, the method comprising:
storing, by a storage device, program code for performing speech analysis;
executing, by a processor, the program code stored in the storage device, the program code causing the processor to be configured to include one or more application modules and at least one trained neural network which causes the processor to perform operations including:
receiving, by the one or more application modules, a natural language input;
decomposing, by the one or more application modules, the natural language into plural segments;
accumulating, by the one or more application modules, a sub-group of the plural segments in a buffer, each segment representing a period during which voice activity is detected;
analyzing, by the one or more application modules, at least one sub-group of segments to determine whether the voice activity includes speech generated by plural speakers;
generating, by the at least one trained neural network, one or more text segments from the at least one sub-group of audio segments based on the plural speaker determination;
generating, by the at least one trained neural network, a semantic vector for each text segment and store each semantic vector in vector memory;
retrieving, by the at least one trained neural network, relevant data associated with each semantic vector from the vector memory; and
generating, by the at least one trained neural network, a response included specified information extracted from the one or more text segments based on at least the relevant information, wherein the response includes a text summary of the voice activity for each text segment.

13. The method according to claim 12, wherein the natural language input is a data file that includes streaming audio data.

14. The method according to claim 12, wherein the natural language input includes streaming audio data received from an audio sensor.

15. The method according to claim 14, wherein decomposing the natural language input into plural audio segments, comprises:
determining, by the one or more application modules, whether voice activity is present in each segment.

16. The method according to claim 15, wherein generating at least one sub-group of audio segments from the plural audio segments, comprises:
identifying each speaker that generates speech in the voice activity of the at least one sub-group of audio segments.

17. The method according to claim 16, wherein the at least one sub-group of segments includes at least one segment for each identified speaker.

18. The method according to claim 17, wherein generating one or more text segments, the processor is further configured to:
determining a source language the speech included in each segment.

19. The method according to claim 18, further comprising:
translating, by the one or more application modules, the one or more text segments from the source language determined for the associated segment to a target language selected by a user.

20. The method according to claim 19, wherein extracting specified data from the one or more text segments comprises:
determining whether all speech in the one or more text segments has been translated and vectorized, prior to the structured data being extracted.

21. The method according to claim 20, wherein extracting the specified data from the one or more text segments is performed using predefined prompts, each predefined prompt being associated with specified data domain.

22. The method according to claim 21, wherein retrieving relevant data associated with each semantic vector from the vector memory, comprises:
searching, by the processor the vector memory based on the specified data to identify the relevant data associated with the one or more text segments that is stored in the vector memory.

23. A non-transitory computer readable medium encoded with system program code for performing speech analysis, when placed in communicable contact with a processor, the computer readable medium causing the processor to generate one or more application modules and at least one trained neural network and be configured to:
receive, by the one or more application modules, a natural language input;
decompose, by the one or more application modules, the natural language input into plural segments;
accumulate, by the one or more application modules, a sub-group of the plural segments in a buffer, each segment representing a period during which voice activity is detected;
analyze, by the one or more application modules, at least one sub-group of segments to determine whether the voice activity includes speech generated by plural speakers;
generate, by the one or more application modules, one or more text segments from the at least one sub-group of audio segments based on the plural speaker determination;
generate, by the one or more application modules, a semantic vector for each text segment and store each semantic vector in vector memory;
retrieve, by the at least one trained neural network, relevant data associated with each semantic vector from the vector memory; and
generate, by the at least one trained neural network, a response included specified information extracted from the one or more text segments based on at least the relevant information, wherein the response includes a text summary of the voice activity for each text segment.

24. A system for multi-lingual speech analysis, the system comprising:
memory configured to store program code for natural language analysis;
a processor configured to execute the program code, the program code causing the processor to be configured to:
receive, by one or more application modules, a natural language input from a user interface;
generate, by the one or more application modules, one or more text segments from the natural language input;
analyze, by the one or more application modules, each text segment to determine a source language of text included in the one or more text segments;
translate, by the one or more application modules, the one or more text segments from the source language determined for the associated audio segment to a target language selected by a user;
generate, by the at least one trained neural network, a vector of each text segment and store the vector in vector memory;
performing, by the at least one trained neural network, a semantic search on the vector memory to retrieve information related to the vector;
passing, by the at least one trained neural network, the retrieved information and the natural language input to another neural network; and
generating, by the other one neural network, a response to the natural language input based on at least the information retrieved from the vector store.
